(19) United States
(12) Patent Application Publication
(10) Pub. No.: US 2005/0212940 A1
(43) Pub. Date: Sep. 29, 2005

(54) CCD solid-state imaging device and digital camera

(75) Inventor: Hirokazu Kobayashi, Saitama (JP)

Correspondence Address: MCGINN & GIBB, PLLC, 8321 OLD COURTHOUSE ROAD, SUITE 200, VIENNA, VA, 22182-3817, US

(73) Assignee: FUJI Photo Film Co., Ltd., Minami-Ashigara-shi (JP)

(21) Appl. No.: 11/090,834

(22) Filed: Mar. 25, 2005

(30) Foreign Application Priority Data
Mar. 29, 2004 (JP) P.2004-094961

(51) Int. Cl. H04N 5/335

(52) U.S. Cl. 348/316

(57) ABSTRACT

A CCD solid-state imaging device in which pixel columns of first pixels in each of which a photodiode that photoelectrically converts green light is formed, and pixel columns of second pixels in each of which a photodiode that photoelectrically converts red light, and a photodiode that photoelectrically converts blue light are formed are alternately formed in a surface portion of a semiconductor substrate, and vertical transfer paths for the first pixels, and vertical transfer paths for the second pixels are alternately arranged between the pixel columns, wherein a width of each of the vertical transfer paths for the second pixels is smaller than a width of each of the vertical transfer paths for the first pixels to increase a light-receiving area of each of the second pixels.

This application is based on Japanese Patent application JP 2004-094961, filed Mar. 29, 2004, the entire content of which is hereby incorporated by reference. This claim for priority benefit is being filed concurrently with the filing of this application.

### BACKGROUND OF THE INVENTION

1. Technical Stage of the Invention

The present invention relates to a CCD solid-state imaging device and a digital camera on which the solid-state imaging device is mounted.

2. Description of the Related Art

As disclosed in, for example, JP-A-1-134966, U.S. Pat. No. 4,613,895, and U.S. Pat. No. 5,965,875, some of solid-state imaging devices are configured so that each pixel detects the three primary colors red (R), green (G), and blue (B). In such a solid-state imaging device, in consideration of the physical property that red light of a long wavelength penetrates to a deepest position of a semiconductor substrate, blue right of a short wavelength penetrates to a shallowest position, and green light of an intermediate wavelength penetrates to an intermediate position, three PN junctions (photodiodes) are disposed in a semiconductor substrate so as to be arranged in the depth direction, and the PN junctions detect incident light amounts of respective colors. However, the configuration in which one pixel detects the three primary colors has a problem in that the spectral sensitivity for each color is so broad that color separation is hardly conducted.

JP-A-2004-273952, one of the assignees of which is the assignee of the present invention proposes a solid-state imaging device in which two kinds of pixels, or a first pixel for detecting green (G), and a second pixels for detecting red (R) and blue (B) are disposed, two PN junctions that are separated from each other in the depth direction are disposed in the second pixel, and a color filter of magenta (Mg) which allows red light and blue light to transmit therethrough, and which blocks green light is stacked on the second pixel.

The solid-state imaging device is configured so that green light of an intermediate wavelength is detected by the first pixel, and red and blue of separate wavelengths are detected by the second pixel, and hence has an advantage that the color separation performance is high.

In a CCD solid-state imaging device, light receiving portions cannot be formed over the whole surface of a semiconductor substrate, and, in addition to the light receiving portions, vertical transfer paths serving as a signal read circuit must be disposed in positions which do not overlap with the light receiving portions. Moreover, each vertical transfer path must have a size which enables signal charges of the amount produced as a result of photoelectric conversion in corresponding light receiving portions to be transferred. However, it is highly requested that the areas of the light receiving portions are made as large as possible in order to enhance the utilization efficiency of light, so as to obtain high-quality image data.

### SUMMARY OF THE INVENTION

It is an object of the invention to provide a CCD solid-state imaging device which comprises first pixels for detecting green, and second pixels for detecting red and blue, and in which the areas of light receiving portions can be made large. It is another object of the invention to provide a digital camera which can take a high-quality color image.

The CCD solid-state imaging device of the invention is a CCD solid-state imaging device in which pixel columns of first pixels in each of which a photodiode that photoelectrically converts green light is formed, and pixel columns of second pixels in each of which a photodiode that photoelectrically converts red light, and a photodiode that photoelectrically converts blue light are formed are alternately formed in a surface portion of a semiconductor substrate, and vertical transfer paths for the first pixels, and vertical transfer paths for the second pixels are alternately arranged between the pixel columns, wherein a width of each of the vertical transfer paths for the second pixels is smaller than a width of each of the vertical transfer paths for the first pixels to increase a light-receiving area of each of the second pixels.

The width of each vertical transfer path for the second pixels and for transferring blue and red signal charges which are produced in a smaller amount under a usual light source is reduced. The light-receiving areas of the second pixels are widened by a degree corresponding to the width reduction. Therefore, the degree at which the amount of the signal charges read out in the second stage is reduced by heat saturation diffusion can be decreased.

In the CCD solid-state imaging device of the invention, the element preferably comprises read gates which selectively read out one or both of red signal charges and blue signal charges of the second pixels, to the vertical transfer paths for the first pixels.

According to the configuration, in the case where a large amount of signal charges are accumulated in the second pixels, the signal charges can be transferred not through the vertical transfer paths for the second pixels having a smaller transfer capacity, but through the vertical transfer paths for the first pixels having a larger transfer capacity. Therefore, it is possible to eliminate a transfer collapse.

The CCD solid-state imaging device of the invention is a CCD solid-state imaging device in which pixel columns of first pixels in each of which a photodiode that photoelectrically converts green light is formed, and pixel columns of second pixels in each of which a photodiode that photoelectrically converts red light, and a photodiode that photoelectrically converts blue light are formed are alternately arranged in a surface portion of a semiconductor substrate, and vertical transfer paths for the first pixels, and vertical transfer paths for the second pixels are alternately arranged between the pixel columns, wherein the element comprises read gates which selectively read out one or both of red signal charges and blue signal charges of the second pixels, to the vertical transfer paths for the first pixels.

According to the configuration, the sequence of reading out the red signal charges and the blue signal charges from the second pixels can be arbitrarily controlled, so that high-quality image data can be obtained.

The digital camera of the invention is characterized in that the camera comprises: any one of the above-described CCD solid-state imaging device according to the invention; and controlling means for driving and controlling the CCD solid-state imaging device.

According to the configuration, it is possible to provide a digital camera which can take a high-quality color image.

Preferably, in the digital camera of the invention, when an ISO sensitivity is higher than a predetermined value, the controlling means causes the red signal charges to be read out and transferred from the second pixels in a first stage, and the blue signal charges to be read out and transferred from the second pixels in a second stage, and, when the ISO sensitivity is not higher than the predetermined value, the controlling means causes the blue signal charges to be read out and transferred from the second pixels in the first stage, and the red signal charges to be read out and transferred from the second pixels in the second stage.

According to the configuration, the dark current of the red signal can be reduced in level, and the image quality in a high ISO sensitivity mode can be improved.

Preferably, in the digital camera of the invention, the controlling means judges a color constituting a main subject, and, in accordance with a result of the judgment, determines whether the red signal charges are read out and transferred from the second pixels in the first stage or in the second stage.

According to the configuration, the dark current of a main subject is reduced, and the image quality can be improved.

The digital camera of the invention is characterized in that the camera comprises: a CCD solid-state imaging device having read gates which selectively read out one or both of red signal charges and blue signal charges of the second pixels, to the vertical transfer paths for the first pixels; and controlling means for detecting a color temperature of a subject, and for, when the color temperature is not higher than a preset value, reading out and transferring the red signal charges of the second pixels to the vertical transfer paths for the first pixels, and, when the color temperature is higher than the preset value, reading out and transferring the blue signal charges of the second pixels to the vertical transfer paths for the first pixels.

A color of a large signal charge amount can be transferred through the vertical transfer paths for the first pixels having a larger capacity. Therefore, the vertical transfer paths for the second pixels can be further narrowed, and the light-receiving areas of the second pixels can be further widened.

According to the invention, a CCD solid-state imaging device having an excellent color separation performance can be provided, and a digital camera which can take a high-quality color image can be provided.

### BRIEF DESCRIPTION OF THE DRAWINGS

FIG. 1 is a block diagram showing the configuration of a digital camera of a first embodiment of the invention.

FIG. 2 is a surface diagram of a solid-state imaging device shown in FIG. 1.

FIG. 3 is a cross-sectional diagram taken along the line III-III in FIG. 2.

FIG. 4 is a timing chart of driving of the solid-state imaging device shown in FIG. 1.

FIG. 5 is a surface diagram of a solid-state imaging device of a second embodiment of the invention.

FIG. 6 is a timing chart of driving of the solid-state imaging device shown in FIG. 5.

FIGS. 7A and 7B are timing charts showing two methods of driving the solid-state imaging device in a third embodiment of the invention.

FIG. 8 is a flowchart showing the procedure of a process of selectively switching the two driving methods shown in FIG. 7.

FIG. 9 is a surface diagram of a solid-state imaging device of a fourth embodiment of the invention.

FIGS. 10A and 10B are timing charts showing two methods of driving the solid-sate imaging device shown in FIG. 9.

FIG. 11 is a flowchart showing the procedure of a process of selectively switching the two driving methods shown in FIG. 10.

FIG. 12 is a flowchart showing the procedure of a process of selectively switching two driving methods in a fifth embodiment of the invention.

### DETAILED DESCRIPTION OF THE INVENTION

Hereinafter, embodiments of the invention will be described with reference to the accompanying drawings.

### First Embodiment

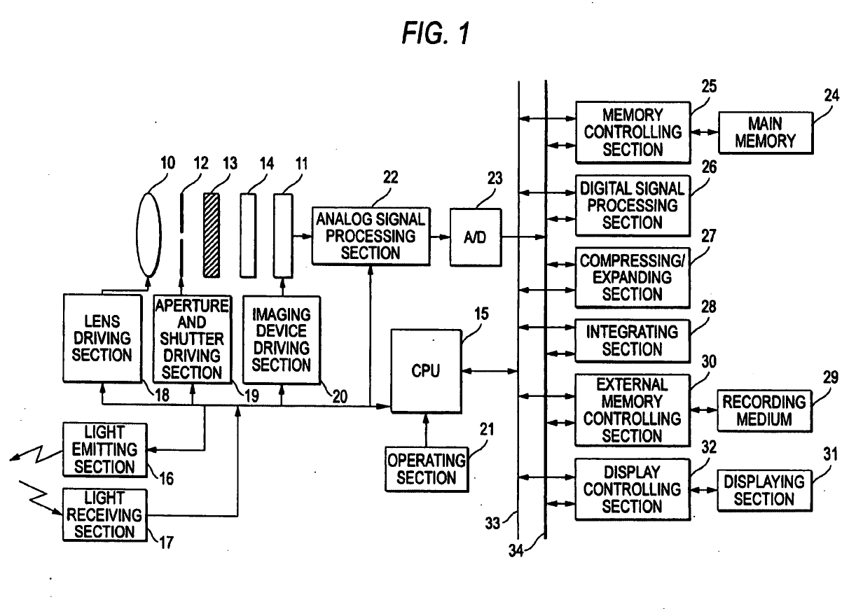

FIG. 1 is a block diagram showing the configuration of a digital still camera of a first embodiment of the invention. Although the embodiment in which the invention is applied to a digital still camera will be described, the invention can be applied also to other kinds of digital cameras such as a digital video camera, and a camera mounted on a small electronic apparatus such as a portable telephone.

The digital still camera shown in FIG. 1 comprises: an imaging lens 10; a CCD solid-state imaging device 11; an aperture and mechanical shutter 12 disposed between the two components; an infrared blocking filter 13; and an optical low-pass filter 14. A CPU 15 which controls the whole digital still camera controls a light emitting section 16 for flash and a light receiving section 17, a lens driving section 18 to adjust the position of the imaging lens 10 to the focus position, an aperture and shutter driving section 19 to control the aperture size via so as to adjust the exposure to an adequate value, and the closing timing of the mechanical shutter.

The CPU 15 drives the solid-state imaging device 11 via an imaging device driving section 20 in a manner which will be described later in detail, so that a subject image taken through the imaging lens 10 is output as color signals. An instruction signal from the user is supplied to the CPU 15 via an operating section 21, and the CPU 15 conducts various controls in accordance with the instructions.

The operating section 21 includes a shutter button. When the shutter button is half-depressed (switch S1), the focus adjustment is conducted, and the method of driving the imaging device 11 is selected. This selection will be described later in detail. When the shutter button is fully depressed (switch S2), the capturing operation is conducted.

An electric control system of the digital still camera comprises an analog signal processing section 22 which is connected to the output of the imaging device 11, and an A/D converter circuit 23 which converts the RGB color signals output from the analog signal processing section 22 to digital signals. These sections are controlled by the CPU 15.

The electric control system of the digital still camera further comprises: a memory controlling section 25 which is connected to a main memory 24; a digital signal processing section 26; a compressing/expanding section 27 which compresses a photographed image to a JPEG image and expands a compressed image; an integrating section 28 which integrates photometric data to enable the gain of white balance to be adjusted: an external memory controlling section 30 to which a detachable recording medium 29 is to be connected; and a display controlling section 32 to which a liquid crystal displaying section 31 mounted on, for example, the back face of the camera is connected. These components are connected to one another through a control bus 33 and a data bus 34, and controlled by instructions from the CPU 15.

In the embodiment, the CPU 15 estimates, for example, the color temperature with using the result of the integration of photometric data in the integrating section 28 (image data in the state of a motion picture received from the imaging device 11 before the shutter button is fully depressed), and analyzes the photometric data (image data) to select the method of driving the imaging device 11 in the manner described later.

The components shown in FIG. 1 such as the digital signal processing section 26 and the A/D converter circuit 23 may be mounted as discrete circuits on the digital still camera. Alternatively, they and the imaging device 11 may be formed on the same semiconductor substrate with using an LSI producing technique so as to be produced as one solid-state imaging device.

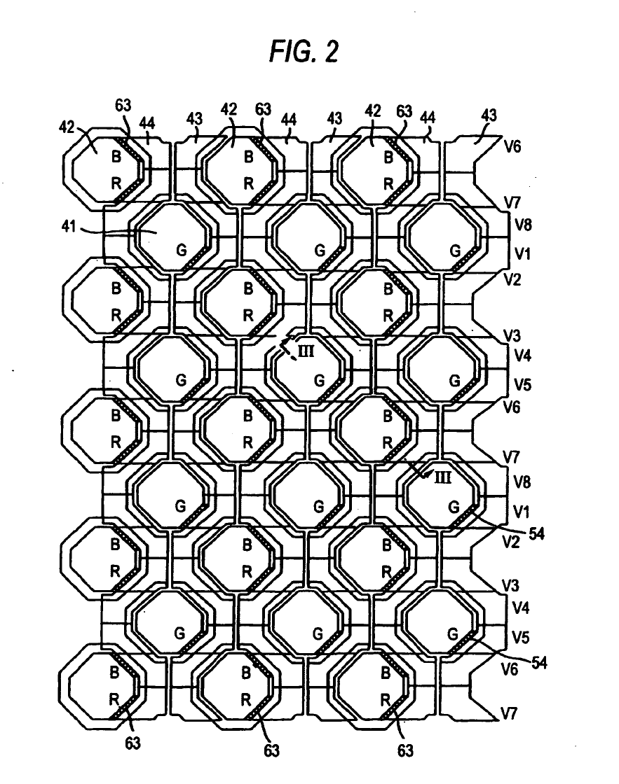

FIG. 2 is a surface diagram of the imaging device 11 which is used in the embodiment. Rows in which second pixels 42 that detect red (R) and blue (B) are arranged are horizontally shifted by ½ of the pixel pitch with respect to rows in which first pixels 41 that detect green (G) are arranged (so-called, honeycomb pixel arrangement). Vertical transfer paths 43, 44 which vertically transfer signal charges read out from the pixels are meanderingly arranged so as to avoid the pixels 41, 42 which are vertically arranged. The vertical transfer paths 43 are meanderingly arranged on the right side of the respective rows of the first pixels 41, and the vertical transfer paths 44 are meanderingly arranged on the right side of the respective rows of the second pixels 42.

The embodiment which is the imaging device 11 of the honeycomb pixel arrangement will be exemplarily described. Alternatively, the invention may be applied also to a CCD solid-state imaging device of the square lattice arrangement.

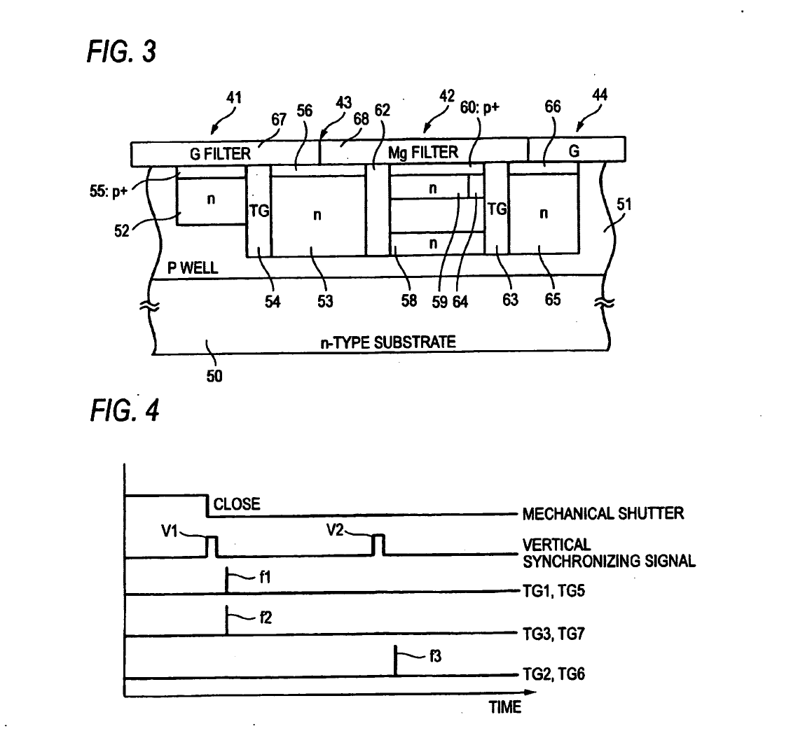

FIG. 3 is a cross-sectional diagram taken along the line III-III in FIG. 2. A P-well layer 51 is formed in a surface portion of an n-type semiconductor substrate 50. An n-region 52 which constitutes the first pixel 41, and which is used for accumulating green signal charges, and an n-region 53 which constitutes the vertical transfer path 43 are disposed in an upper portion of the P-well layer. A trench gate 54 which serves as a read gate is formed between the two regions. A p-type heavily-doped impurity layer 55 is formed in a surface portion of the n-region 52. A light shielding film 56 is formed in a surface portion of the vertical transfer path 43.

In the surface portion of the P-well layer 51, an n-region 58 for accumulating red signal charges is formed at a deep position, and an n-region 59 for accumulating blue signal charges is formed at a shallow position so as to be separated from the n-region 58. A p-type heavily-doped impurity layer 69 is formed in a surface portion of the n-region 59. The n-regions 58, 59 constitute the second pixel 42. The n-regions 58, 59 are separated from the n-region 53 by a channel stop 62. A trench gate 63 for reading out signal charges from the n-regions 58, 59 is formed on the right side of the n-regions 58, 59.

The section position by the line III-III in FIG. 2 does not coincide with a position where blue signal charges are to be read out. In FIG. 3, therefore, a channel stop 64 is disposed between the n-region 59 and the trench gate 63. In the n-region 59 which is adjacent to the trench gate for reading out blue signal charges, the channel stop 64 shown in FIG. 3 is not formed (not shown), and instead a channel stop is disposed between the trench gate 63 and the n-region 58 (the channel stop is not shown).

In FIG. 2, G, R, and B which respectively show colors to be read out are written at the sides of the trench gates 54, 63 of the first pixels 41 and the second pixels 42 so as to indicate the colors which are to be read out through the trench gates, respectively. Hereinafter, trench gates TG1, TG2, . . . , TG8 mean trench gates which are disposed in vertical transfer paths V1, V2, . . . , V8 (see the right end of FIG. 2) to which the same number is affixed, respectively.

Referring again to FIG. 3, an n-region 65 which constitutes the vertical transfer path 44 is formed on the right side of the trench gate 63, and a light shielding film 66 is formed in a surface portion of the n-region. A G filter 67 which allows incident light of green (G) to transmit therethrough, and which blocks other colors is stacked on the first pixel 41, and a magenta (Mg) filter 68 which allows incident light of red (R) and blue (B) to transmit therethrough, and which blocks incident light of green (G) is stacked on the second pixel 42.

The first pixels 41 are continuously formed in the longitudinal direction (vertical direction), and also the second pixels 42 are arranged in the longitudinal direction (vertical direction). Therefore, the green (G) filter 67 and the magenta (Mg) filter 68 are formed in a vertical striped pattern. When color filters are formed in a vertical striped pattern as described above, the same color is transferred through the identical vertical transfer path (when the vertical transfer paths 43 are to transfer green signal charges, for example, all signal charges on the vertical transfer paths 43 are green signal charges), thereby preventing color mixture from occurring.

In the embodiment, as shown in FIG. 3, the width of the vertical transfer path 44 which transfers red and blue signal charges is made smaller than that of the vertical transfer path 43 which transfers green signal charges, and instead the light-receiving area of the second pixel 42 is made larger than that of the first pixel 41.

This configuration is employed because, in a capturing process under a usual light source such as sunlihgt, a fluorescent lamp, or an incandescent lamp, blue and red signal charges are small in amount, and hence the vertical transfer path 44 is not required to have a large transfer capacity. Therefore, the two photodiodes for blue and red in the second pixel 42 have a large saturation capacity, so that heat saturation diffusion in multistage reading of signal charges from the second pixel 42 can be compensated.

FIG. 4 is a timing chart of reading out red (R), green (G), and blue (B) signal charges from the imaging device 11 shown in FIG. 2. In the imaging device 11 of the embodiment, two-stage reading is conducted. Namely, after the mechanical shutter 12 is closed and a first vertical synchronizing signal V1 is generated, a read pulse f1 is applied to the trench gates TG1, TG5, and at the same time a read pulse f2 is applied to the trench gates TG3, TG7.

As a result, green signal charges are read out from the first pixels 41 to the vertical transfer paths 43, and red signal charges are read out from the second pixels 42 to the vertical transfer paths 44. In accordance with transfer pulses which are not shown, the read out signal charges are vertically transferred through the vertical transfer paths 43, 44 to a horizontal transfer path which is not shown.

When a second vertical synchronizing signal V2 is thereafter generated, a read pulse f3 is applied to the trench gates TG2, TG6. As a result, blue signal charges are read out to the vertical transfer paths 44, and then transferred to the horizontal transfer path in accordance with the transfer pulses which are not shown.

As described above, in the embodiment, the vertical transfer paths 44 are narrowed, and the light-receiving areas of the second pixels 42 are increased. Consequently, the photodiode saturation capacity of each second pixel 42 is increased. Even when the signal charge amount which is to be read out from the second pixel 42 is heat saturation diffused in the first stage, therefore, the diffusion exerts less effect.

### Second Embodiment

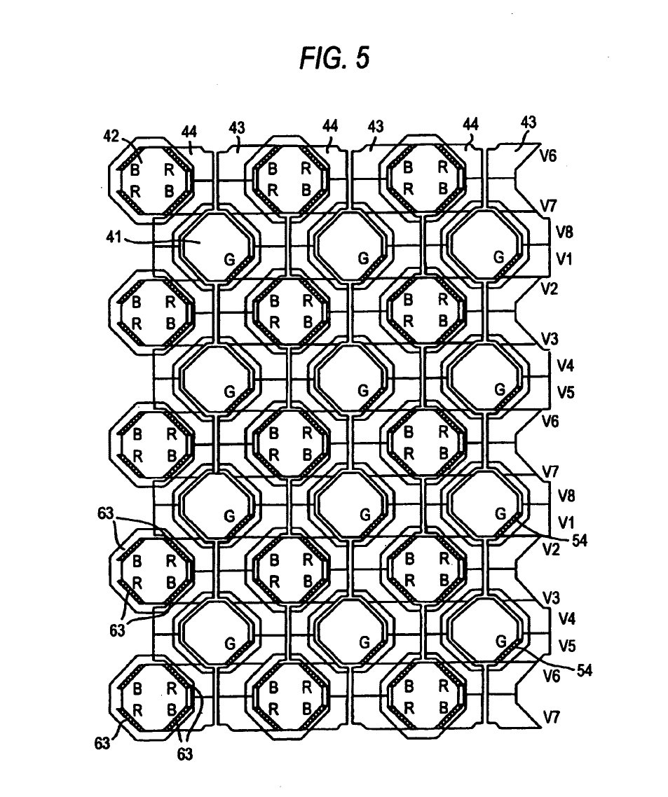

FIG. 5 is a surface diagram of a solid-state imaging device of a second embodiment of the invention. In the embodiment, the configuration of a digital camera, and the basic sectional structure of each pixel are identical with those in the first embodiment. However, the embodiment is different from the first embodiment in that trench gates are disposed so that signal charges of the n-regions 58, 59 can be read out not only to the narrow vertical transfer paths 44 which are on the right side, but also to the vertical transfer paths 43 which are on the left side, and which are wide (i.e., have a large transfer capacity).

Specifically, a trench gate is disposed in the place where the channel stop 62 shown in FIG. 3 is formed, so that red or blue signal charges can be read out to the n-region 53 of the corresponding vertical transfer path 43. In other words, in the embodiment, four trench gates are disposed in each of the second pixels 42. In FIG. 5, in the same manner as FIG. 2, the colors R, G, and B of signal charges to be read out are written at the sides of the trench gates to indicate the colors which are to be read out through the trench gates, respectively.

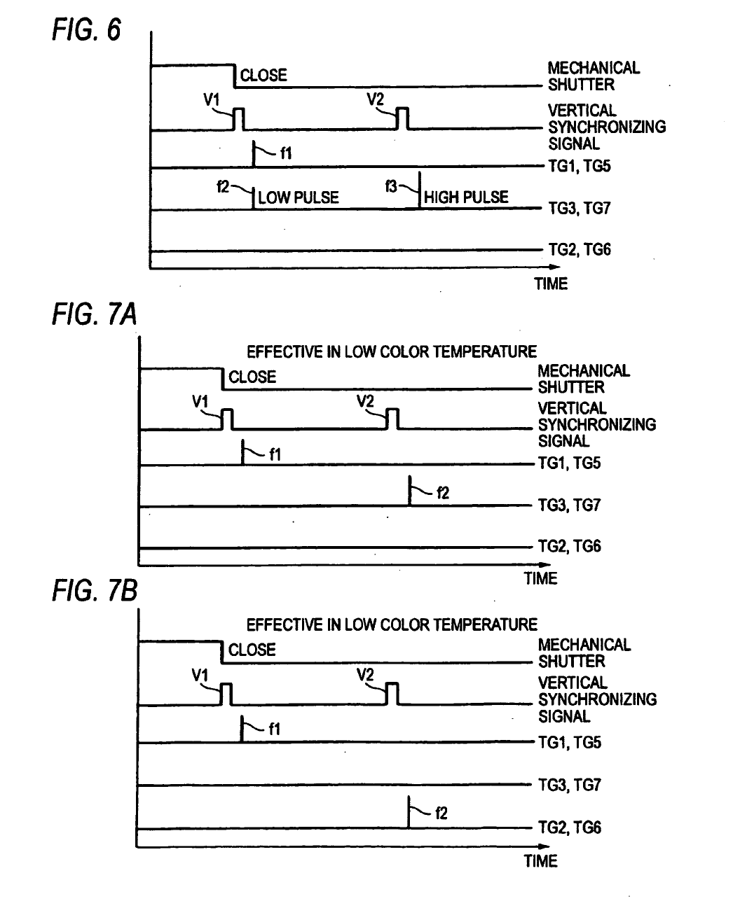

FIG. 6 is a timing chart of reading out red (R), green (G), and blue (B) signal charges from the imaging device 11 shown in FIG. 5. Also in the imaging device 11 of the embodiment, two-stage reading is conducted. Namely, after the mechanical shutter is closed and the first vertical synchronizing signal V1 is generated, the read pulse f1 is applied to the trench gates TG1, TG5, and at the same time the read pulse f2 is applied to the trench gates TG3, TG7. In the embodiment, however, the voltage of the read pulse f2 is low.

In each of the second pixels 42, the n-region 58 for accumulating red signal charges is formed at a deep position, and the n-region 59 for accumulating blue signal charges is formed at a shallow position. When the read pulse f2 of a low voltage is applied to the trench gates TG3, TG7, therefore, red signal charges cannot be read out from the n-regions 58 to the vertical transfer paths 43, and only blue signal charges are read out to the vertical transfer paths 44.

Therefore, the vertical transfer paths 43 transfer only green signal charges, and the vertical transfer paths 44 only blue signal charges to the horizontal transfer path. When the read pulse f3 of a high voltage is applied to the trench gates TG3, TG7 after the subsequent second vertical synchronizing signal V2 is supplied, red signal charges are read out to the vertical transfer paths 43, and then transferred to the horizontal transfer path. At this time, all blue signal charges have been already read out from the n-regions 59 by the application of the read pulse f2, and hence no signal charges are read out to the vertical transfer paths 44.

As described above, the embodiment is configured so that, among red (R), green (G), and blue (B), red (R) and green (G) are transferred through the wider vertical transfer paths 43, blue (B) in which the signal amount is small is transferred through the narrower vertical transfer paths 44. Therefore, the possibility that capacitance collapse occurs in the vertical transfer paths can be further eliminated. Consequently, the vertical transfer paths 44 can be reduced in width, so that the light-receiving area of each of the second pixels 42 is increased.

### Third Embodiment

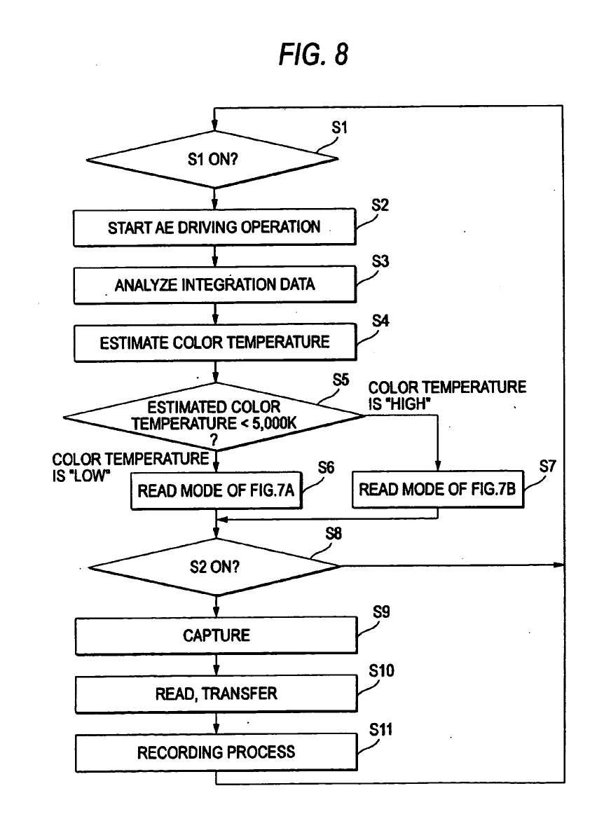

FIGS. 7A and 7B are timing charts of driving the imaging device 11 in a digital cameral of a third embodiment of the invention. The digital camera is configured in the same manner as that of FIG. 1, and the imaging device 11 is configured in the same manner as that of the second embodiment shown in FIG. 5. In the embodiment, one of the driving methods of FIGS. 7A and 7B is selected as the method of driving the imaging device 11.

In FIG. 7A, after the mechanical shutter is closed and the first vertical synchronizing signal V1 is then generated, the read pulse f1 is applied to the trench gates TG1, TG5. As a result, green (G) signal charges are read out to the wider vertical transfer paths 43. After the signal charges are transferred to the horizontal transfer path and the second vertical synchronizing signal V2 is then generated, the read pulse f2 is applied to the trench gates TG3, TG7. As a result, red signal charges are read out to the wider vertical transfer paths 43, blue signal charges are read out to the narrower vertical transfer paths 44, and these signal charges are then transferred.

In FIG. 7B, after the mechanical shutter is closed and the first vertical synchronizing signal V1 is then generated, the read pulse f1 is applied to the trench gates TG1, TG5. As a result, green (G) signal charges are read out to the wider vertical transfer paths 43. After the signal charges are transferred to the horizontal transfer path and the second vertical synchronizing signal V2 is then generated, the read pulse f2 is applied to the trench gates TG2, TG6. As a result, in contrast to FIG. 7A, blue signal charges are read out to the wider vertical transfer paths 43, red signal charges are read out to the narrower vertical transfer paths 44, and these signal charges are then transferred.

FIG. 8 is a flowchart showing the process procedure which is implemented by the CPU 15 of the digital camera in the embodiment. When the shutter button is half-depressed (switch S1 is turned ON) (step S1), the AE driving operation is started (step S2), the result of the integration in the integrating section 28 is analyzed (step S3), and the color temperature of the photometric data is estimated (step S4).

Then, it is judged whether the estimated color temperature is lower than a preset temperature, for example, 5,000K or not (step S5). If the color temperature is lower than the value, the amount of red signal charges is large, and hence the driving method of FIG. 7A is selected so that red signal charges are read out to the wider vertical transfer paths 43 (step S6).

If the estimated color temperature is higher than 5,000K, the amount of blue signal charges is large, and hence the driving method of FIG. 7B is selected in order to read out blue signal charges to the wider vertical transfer paths 43 (step S7).

After the method of driving the imaging device 11 is selected, the process waits for full-depression of the shutter button (switch S2 is turned ON) (step S8). If the shutter button is not fully depressed, the process returns to step S1. If the shutter button is fully depressed, the capturing operation is conducted (step S9). Signal charges are read out and then transferred by the selected driving method (step S10), and image signals of the three primary colors of R, G, and B read out from the imaging device 11 are processed and then recorded into an external memory (step S1). Thereafter, the process returns to step S1.

In the embodiment, depending on the color temperature of image data (photometric data), signal charges which are accumulated in the second pixels, and which have a large amount are read out to the vertical transfer paths which are wider, or which have a larger transfer capacity. Even when the narrow vertical transfer paths 44 are made narrower, therefore, a transfer collapse does not occur, and the light-receiving areas of the second pixels can be further widened.

### Fourth Embodiment

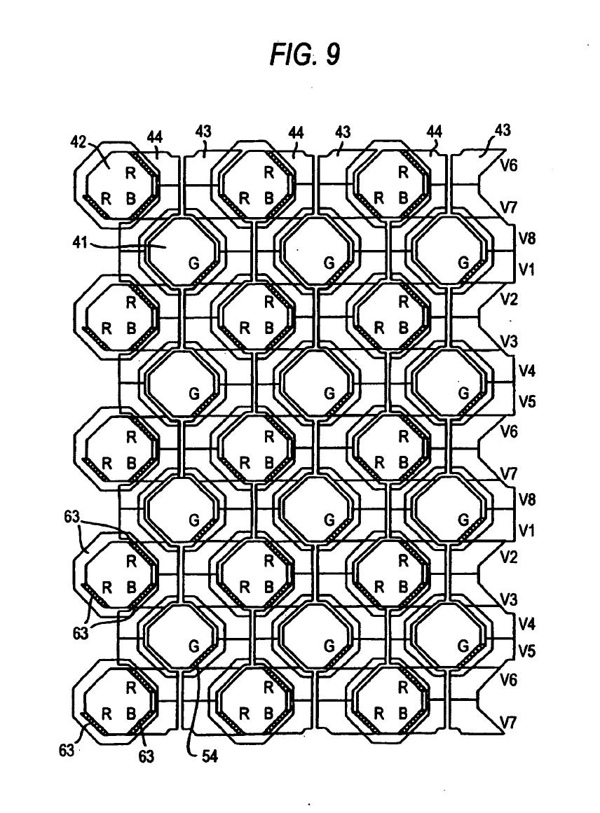

FIG. 9 is a surface diagram of a solid-state imaging device in a fourth embodiment of the invention. In the embodiment, the configuration of a digital camera, and the basic sectional structure of each pixel are identical with those in the first embodiment. However, the embodiment is different from the first embodiment only in that, among the four trench gates of each of the second pixels 42 shown in FIG. 5, the trench gate which is opposed to the diagonally left trench gate for G is eliminated. In FIG. 9, in the same manner as FIGS. 2 and 5, the colors R, G, and B of signal charges to be read out are written at the sides of the trench gates to indicate the colors which are to be read out through the trench gates, respectively.

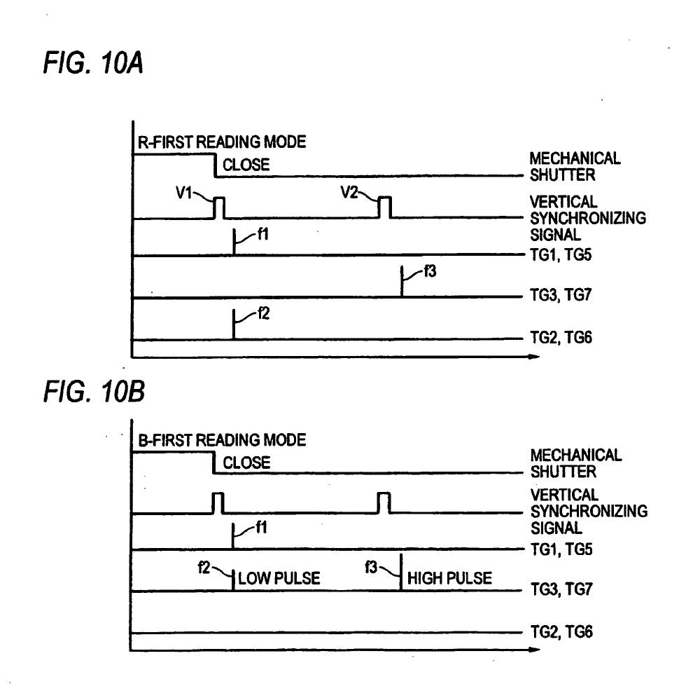

FIGS. 10A and 10B are timing charts of driving the imaging device 11 in a digital cameral of the fourth embodiment of the invention. In the embodiment, one of the driving methods of FIGS. 10A and 10B is selected as the method of driving the imaging device 11.

In FIG. 10A, after the mechanical shutter is closed and the first vertical synchronizing signal V1 is then generated, the read pulse f1 is applied to the trench gates TG1, TG5. As a result, green (G) signal charges are read out to the wider vertical transfer paths 43. At the same time, the read pulse f2 is applied to the trench gates TG2, TG6. As a result, red signal charges are read out to the narrower vertical transfer paths 44.

After the second vertical synchronizing signal V2 is generated after the signal charges are transferred to the horizontal transfer path, the read pulse f2 is applied to the trench gates TG3, TG7. As a result, blue signal charges are read out to the narrower vertical transfer paths 44, and then transferred. In the driving method of FIG. 10A, red signal charges are first read out from the second pixels 42. Therefore, this method is referred to as R-first reading mode.

In FIG. 10B, after the mechanical shutter is closed and the first vertical synchronizing signal V1 is then generated, the read pulse f1 is applied to the trench gates TG1, TG5. As a result, green (G) signal charges are read out to the wider vertical transfer paths 43. At the same time, the read pulse f2 of a low voltage is applied to the trench gates TG3, TG7. As a result, blue signal charges are read out only from the shallow n-region 59 to the narrower vertical transfer path 44.

After the signal charges are transferred to the horizontal transfer path and the second vertical synchronizing signal V2 is then generated, the read pulse f3 of a high voltage is applied to the trench gates TG3, TG7. As a result, red signal charges are read out from the deep n-region 58 to the wider vertical transfer path 43, red signal charges are read out to the narrower vertical transfer path 44, and the signal charges are then transferred. In the driving method of FIG. 10B, blue signal charges are first read out from the second pixels 42. Therefore, this method is referred to as B-first reading mode.

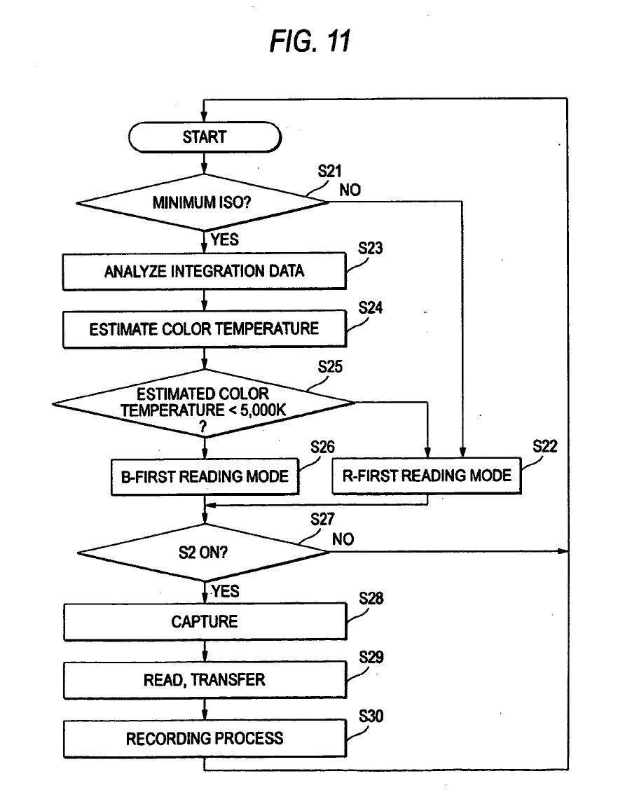

FIG. 11 is a flowchart showing the process procedure which is implemented by the CPU 15 of the digital camera in the embodiment. When the process is started, it is first judged whether the preset ISO sensitivity of the digital camera is equal to or lower than a predetermined ISO sensitivity or not, for example, whether the preset ISO sensitivity is the minimum ISO sensitivity or not (step S21). If the preset ISO sensitivity is not the minimum ISO sensitivity, the process advances to step S22 to set the driving method of the imaging device 11 to the R-first reading mode of FIG. 10A.

If the preset ISO sensitivity is the minimum ISO sensitivity, the result of the integration of the photometric data (image data) is analyzed (step S23), and the color temperature of the photometric data is estimated (step S24).

Then, it is judged whether the estimated color temperature is lower than a preset temperature, for example, 5,000K or not (step S25). If the color temperature is not lower than 5,000K, the process proceeds to step S22 to set the R-first reading mode, and, if the color temperature is lower than 5,000K, the process proceeds to step S26 to set the B-first reading mode (FIG. 10B).

After the method of driving the imaging device 11 is set, the process waits for full-depression of the shutter button (switch S2 is turned ON) (step S27). If the shutter button is not fully depressed, the process returns to the start. If the shutter button is fully depressed, the capturing operation is conducted (step S28). Signal charges are read out and then transferred by the selected driving method (step S29), and image signals of the three primary colors of R, G, and B read out from the imaging device 11 are processed and then recorded into an external memory (step S30). Thereafter, the process returns to the start.

In the embodiment, when the ISO sensitivity is other than the minimum ISO sensitivity, red signal charges are read out in advance in the first stage. Therefore, the dark current of the red signal can be reduced in level, and the image quality in a high ISO sensitivity mode can be improved. In a high ISO sensitivity mode, the signal charge amount is small, and hence a transfer collapse due to an insufficient capacity of a vertical transfer path does not occur. The reduction of the dark current of the red signal is effective in reducing flesh color noises.

### Fifth Embodiment

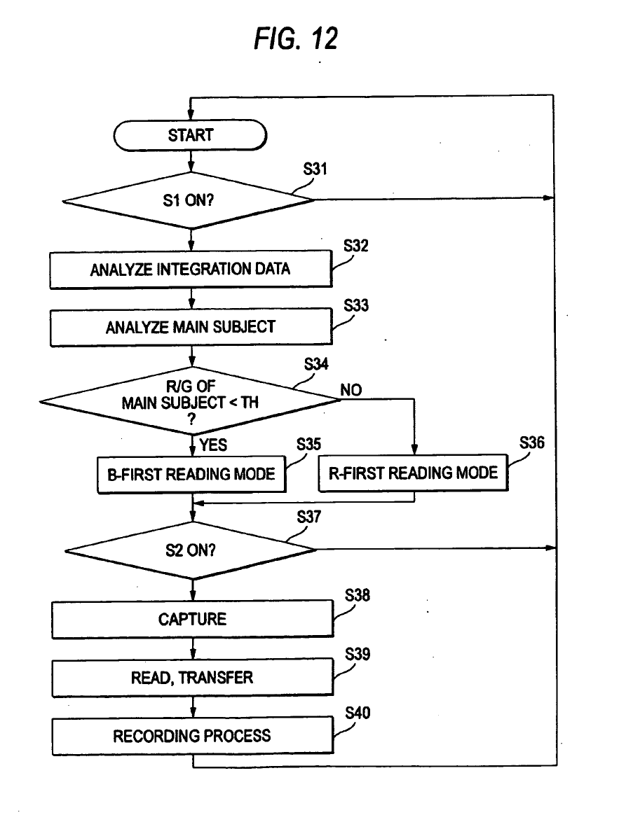

FIG. 12 is a flowchart showing the process procedure in a fifth embodiment of the invention. The embodiment is basically identical with the fourth embodiment except that a different the criterion for the selection of the B-first reading mode (FIG. 10B) and the R-first reading mode (FIG. 10A) is employed. In the embodiment, the vertical transfer paths 43, 44 may have the same width.

When the process is started, the process waits for half-depression of the shutter button (switch S1 is turned ON) (step S31). When the switch S1 is turned ON, the photometric data (image data) are analyzed (step S32) to determine the main subject in the image data (step S33).

Next, based on the result of the integration of the image data of the main subject portion, it is determined whether the value of R/G is smaller than a threshold TH or not (step S34). If R/G of the main subject portion is smaller than the threshold TH, the process advances to step S35 to select the B-first reading mode (FIG. 10B), and, if R/G≧TH, the process advances to step S36 to select the R-first reading mode (FIG. 10A).

After the method of driving the imaging device 11 is selected, the process waits for full-depression of the shutter button (switch S2 is turned ON) (step S37). If the shutter button is not fully depressed, the process returns to the start. If the shutter button is fully depressed, the capturing operation is conducted (step S38). Signal charges are read out and then transferred by the selected driving method (step S39), and image signals of the three primary colors of R, G, and B read out from the imaging device 11 are processed and then recorded into an external memory (step S40). Thereafter, the process returns to the start.

According to the embodiment, with using the area integration information (the result of the integration of photometric data of the main subject portion) in the case of the switch S1, the amount of the color component constituting a main subject is determined, and the color is read out in the first stage. Therefore, the dark current of image data of the main subject is reduced, and the image quality can be enhanced.

The solid-state imaging device of the invention has an excellent color separation performance, and, even when two-stage reading is conducted, can obtain image data of high quality. Therefore, the solid-state imaging device can be usefully mounted on a digital camera.

1. A CCD solid-state imaging device comprising:
a semiconductor substrate;
first pixel columns of first pixels each comprising a photodiode that photoelectrically converts a green light;
second pixel columns of second pixels each comprising a photodiode that photoelectrically converts a red light and a photodiode that photoelectrically converts a blue light, the first pixel columns and the second pixel columns being arranged in an alternate state;
first vertical transfer paths for the first pixels;
second vertical transfer paths for the second pixels, the first vertical transfer paths and the second vertical transfer paths being arranged in an alternative state between the first pixel columns and the second pixel columns, wherein
a width of each of the second vertical transfer paths is smaller than a width of each of the first vertical transfer paths to increase a light-receiving area of each of the second pixels.

2. The CCD solid-state imaging device according to claim 1, which further comprises read gates which selectively read out one or both of red signal charges and blue signal charges of the second pixels to the first vertical transfer paths.

3. A digital camera comprising: the CCD solid-state imaging device according to claim 1; and a controlling unit that drives and controls the CCD solid-state imaging device.

4. The digital camera according to claim 3, wherein,
when an ISO sensitivity is higher than a value, the controlling unit causes the red signal charges to be read out and transferred from the second pixels in a first field, and the blue signal charges to be read out and transferred from the second pixels in a second field, and,
when the ISO sensitivity is not higher than the value, the controlling unit causes the blue signal charges to be read out and transferred from the second pixels in the first field, and the red signal charges to be read out and transferred from the second pixels in the second field.

5. The digital camera according to claim 4, wherein the controlling unit judges a color constituting a main subject, and, in accordance with a result of the judgment, determines whether the red signal charges are read out and transferred from the second pixels in the first field or in the second field.

6. A digital camera comprising:
the CCD solid-state imaging device according to claim 2; and
a controlling unit that detects a color temperature of a subject, and
that, when the color temperature is not higher than a value, reads out and transfers the red signal charges of the second pixels to the first vertical transfer paths, and,
that, when the color temperature is higher than the value, reads out and transfers the blue signal charges of the second pixels to the first vertical transfer paths.

7. A CCD solid-state imaging device comprising:
a semiconductor substrate;
first pixel columns of first pixels each comprising a photodiode that photoelectrically converts a green light;
second pixel columns of second pixels each comprising a photodiode that photoelectrically converts a red light and a photodiode that photoelectrically converts a blue light, the first pixel columns and the second pixel columns being arranged in an alternate state;
first vertical transfer paths for the first pixels;
second vertical transfer paths for the second pixels, the first vertical transfer paths and the second vertical transfer paths being arranged in an alternative state between the first pixel columns and the second pixel columns; and
read gates that selectively read out one or both of red signal charges and blue signal charges of the second pixels to the first vertical transfer paths.

8. A digital camera comprising: a CCD solid-state imaging device according to claim 7; and a controlling unit that drives and controls the CCD solid-state imaging device.

9. The digital camera according to claim 7, wherein, when an ISO sensitivity is higher than a value, the controlling unit causes the red signal charges to be read out and transferred from the second pixels in a first field, and the blue signal charges to be read out and transferred from the second pixels in a second field, and, when the ISO sensitivity is not higher than the value, the controlling unit causes the blue signal charges to be read out and transferred from the second pixels in the first field, and the red signal charges to be read out and transferred from the second pixels in the second field.

10. The digital camera according to claim 7, wherein the controlling unit judges a color constituting a main subject, and, in accordance with a result of the judgment, determines whether the red signal charges are read out and transferred from the second pixels in the first field or in the second field.

11. A digital camera comprising:
the CCD solid-state imaging device according to claim 7; and
a controlling unit that detects a color temperature of a subject, and
that, when the color temperature is not higher than a value, reads out and transfers the red signal charges of the second pixels to the first vertical transfer paths, and
that, when the color temperature is higher than the value, reads out and transfers the blue signal charges of the second pixels to the first vertical transfer paths.
